(19) United States
(12) Patent Application Publication
(10) Pub. No.: US 2010/0292941 A1
(43) Pub. Date: Nov. 18, 2010

(54) PRESSURE SENSOR WITH SENSOR CHARACTERISTIC MEMORY

(76) Inventor: Francesco Grasso, Beaverton, OR (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/779,466

(22) Filed: May 13, 2010

Related U.S. Application Data
(60) Provisional application No. 61/216,222, filed on May 14, 2009.

(51) Int. Cl. G01L 7/00

(52) U.S. Cl. 702/50

(57) ABSTRACT

A pressure sensor includes a memory in which sensor characterization data is stored.

### CROSS-REFERENCE TO RELATED APPLICATIONS

This application claims the benefit of U.S. Provisional App. No. 61/216,222, filed May 14, 2009.

### BACKGROUND OF THE INVENTION

The present invention relates to pressure sensors and, more specifically, to a pressure sensor having a memory for storing characteristics of the sensor.

Pressure sensors are used for controlling and monitoring fluid pressure in thousands of hydraulic and pneumatic applications. Pressure sensors are also used to indirectly measure variables such as fluid flow, speed, fluid level and altitude. There are number of different technologies used in the construction of pressures sensors. For example, strain gauges can be used to measure the strain or deformation of a structure exposed to a pressurized fluid. Semiconductor piezoresistance, the change in conductivity of a semiconductor under pressure, can also be used to sense pressure. A change in capacitance as a result of a change in the distance between two conductive plates when subjected to fluid pressure is another technology commonly used in pressure sensors.

Ideally, the output of a pressure sensor would vary linearly with a change in pressure. However, the output of pressure sensors is not ideal and it typically non-linear, particularly with respect to pressure and temperature. To obtain accurate measurements, the user typically profiles a pressure sensor by measuring the output at a plurality of different pressures and temperatures and by developing an electronic circuit or an algorithm for a digital computer that accounts for the non-linearity of the sensor. Profiling is time consuming and because of the cost is often only performed at a single temperature even though the accuracy of the sensor may be less than desirable at other temperatures.

What is desired, therefore, is an effective, low cost way obtaining accurate readings from a pressure sensor.

### BRIEF DESCRIPTION OF THE DRAWINGS

FIG. 1 is an elevation view of an exemplary pressure sensor.

FIG. 2 is a section view of the exemplary pressure sensor of FIG. 1 taken along line A-A.

FIG. 3 is a block diagram of pressure measuring system.

FIG. 4 is a flow diagram of a method of determining pressure.

### DETAILED DESCRIPTION OF PREFERRED EMBODIMENTS

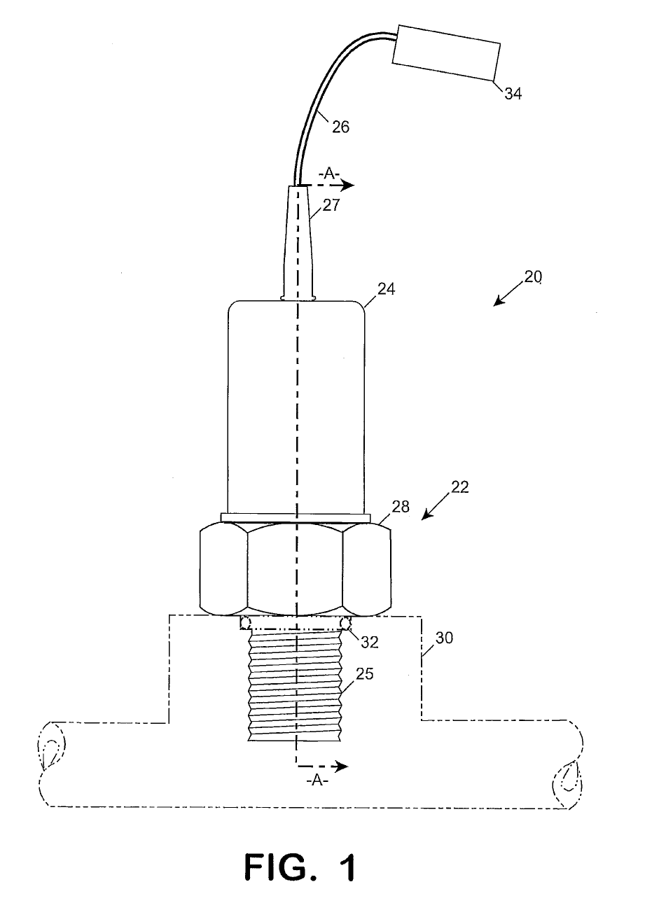

Referring in detail to the drawings where similar parts are identified by like reference numerals, and, more particularly to FIG. 1, an exemplary pressure sensor 20 comprises, generally, a body 22, an enclosure 24 and cabling 26 for connecting the sensor to other elements of a pressure measuring system. The body includes a threaded portion 25 enabling threaded engagement with a port 30 of manifold or other access to a passage containing a pressurized fluid. Wrench flats 28 on the body of the exemplary sensor facilitate tightening the threaded connection between the port and the pressure sensor. Typically, a gasket, an o-ring 32 or other sealing element provides a fluid tight connection between the port and the body of the pressure sensor. The cabling is protected by a strain relief 27 and includes a connector 34 for electrically coupling the sensor to other elements of a pressure measurement system.

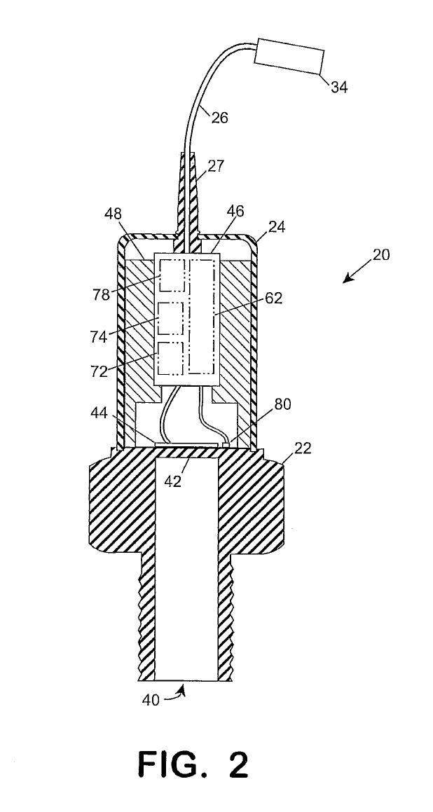

Referring to FIG. 2, a pressure sensor typically comprises a structure that is deformable by the pressure of the fluid and a transducer that converts the structural deformation to an electrical output. In the exemplary pressure sensor 20, the body 22 is hollow comprising an axially extending passage 40 that fills with pressurized fluid from the interior of the manifold. An end portion 42 of the body terminates the passage and in most sensors is readily deformable by the pressure of the fluid. One or more transducers 44 are affixed to the end portion and output an electrical signal in response to strain, the deformation of the end portion caused by the pressurized fluid. The transducers are commonly strain gauges that are rigidly affixed to the end portion. Deformation of the end portion deforms a conductive element of the strain gauge causing a change in the resistance of the conductive element. Similarly, the transducer may be a piezoresistance device comprising a semiconductor element having a resistance that is variable as the element is deformed. The semiconductor element may be affixed to the end portion of the body or may be affixed to close the end of an open passage forming an end cap for the passage. Some pressure sensors utilize a capacitive transducer comprising two, spaced apart metal plates. When pressure deforms or displaces one of the plates, the capacitance between the plates changes providing a signal indicative of the pressure.

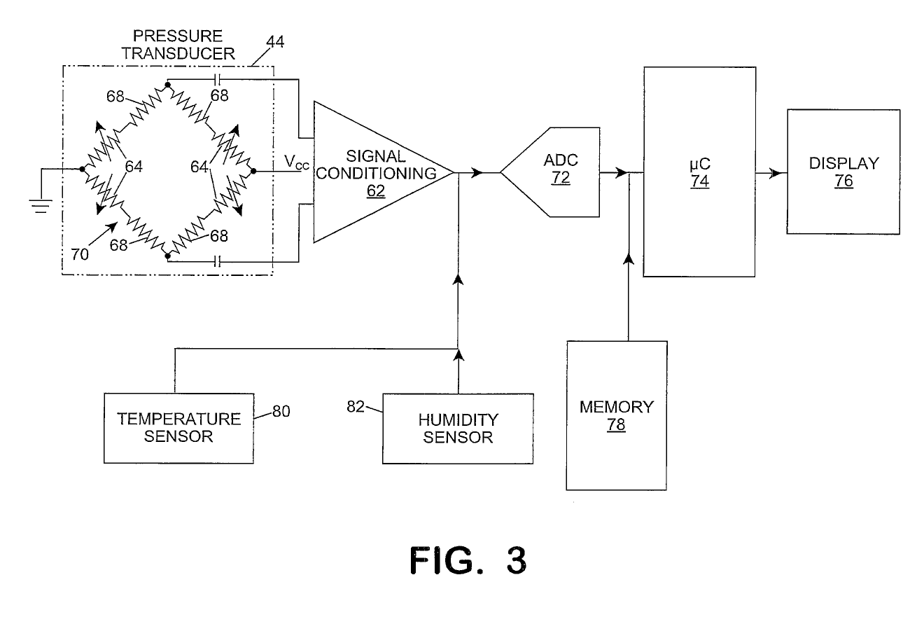

Referring also to FIG. 3, the exemplary transducer 44 of the pressure sensor is conductively connected to a signal conditioning circuit 62 in an electrical module 46 that is supported in the enclosure by a support block 48. By way of examples, a pressure transducer 44 may comprise a plurality of strain gauges or piezoresistance elements with each variable resistance strain gauge or piezoresistance element 64 connected to a fixed resistor 68 in a leg of a Wheatstone bridge 70. The output of the bridge is conductively connected to the signal conditioning module 62 that typically provides signal amplification and bandwidth limiting for the transducer output. The pressure transducer signal is typically in the millivolt range and must be amplified to a level that is within the range of the analog-to-digital converter (ADC) 72 at the output of the signal conditioning unit. In addition, the signal conditioning unit typically includes a low-pass filter function to filter out high frequency components of the signal which may exceed the frequency limitations of the ADC. The signal conditioning unit is connected to an ADC 72 that converts the analog output of the signal conditioning unit to a digital output for use by a digital processor 74. The processor, typically, a micro-controller, may be integrated into the electrical module of the pressure sensor as illustrated in FIG. 2 or may be remote from the pressure sensor and connected to the pressure sensor by cabling that enables data communication between the pressure sensor and the processor. The processor may connected directly to a display 76 enabling viewing of the output of the pressure sensor and/or it may connected to transmit the output to another data processor for further processing as part of a larger system that consumes pressure data.

Ideally the output of a pressure transducer would have a linear relationship to the pressure. However, the relationship of the pressure and output signal is seldom linear and varies with the type of transducer. In addition, the transducer output is commonly substantially affected by temperature and may be affected by other environmental factors, such as humidity. Before using a pressure sensor, the sensor must be profiled wherein the output of the sensor is measured and recorded at a plurality of different pressures, temperatures and other environmental conditions that may affect the linearity of the transducer's output. Profiling enables development of circuitry or an algorithm for a digital data processor that accounts for the non-ideal characteristics of the pressure sensor but profiling is a time consuming process and, therefore, expensive and often the effects of temperature and other factors are ignored to reduce the cost of the system incorporating the pressure sensor. However, the manufacturer of the pressure sensor typically tests each sensor to determine that the individual sensor conforms to the appropriate specification. These tests are typically performed by automated equipment and are relatively inexpensive compared to the profiling performed by the user. The present inventor concluded that substantial time and expense could be avoided if the manufacturer of the pressure sensor stored the characterizing data for the pressure sensor obtained during testing of the sensor in the sensor itself.

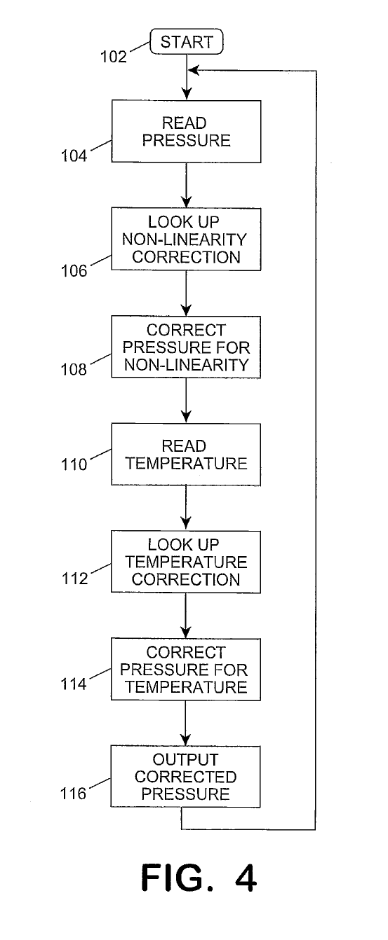

The exemplary pressure sensor 20 includes a non-volatile memory 78, such as an EEPROM or flash memory in which data characterizing the pressure transducer is stored. The data typically includes linearization data specifying the deviation of the transducer's output from a linear relationship relative to the pressure. The characteristic data may also include corrections for the output of the sensor as a function of temperature and the exemplary pressure sensor includes a temperature sensor 80 affixed to the body of the sensor with an output connected to the ADC 72. Other characterization data, such as a correction for humidity and/or time, may also be stored in the memory as appropriate and the pressure sensor may include a humidity transducer 82 or other transducers enabling quantification of other parameters that affect the accuracy of the output of the sensor. When the pressure sensor is tested during manufacturing the characteristic data is captured by the test instrumentation and stored in the memory. Referring to FIG. 4, when the pressure sensor is used 102; the processor 74 reads the output of the pressure transducer 104. The processor looks up characterization data stored in the memory 78 that quantifies the non-linear behavior of the transducer 106 and modifies the pressure to account for the non-linear behavior of the transducer 108. The processor also reads the temperature sensor 110 and looks up the appropriate temperature correction data stored in the memory 112. The pressure is corrected to reflect the effects of temperature 114 and the corrected pressure is output to a display or another consumer of pressure data 116. Similarly, the measured pressure can be corrected for other sources of inaccuracy, such as other environmental factors.

The memory in the pressure sensor enables storage of characterization data by the manufacturer of the sensor enabling the user pressure sensor to obtain accurate readings without time consuming and expensive profiling of the sensor.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A pressure sensor comprising:
(a) a pressure transducer; and
(b) a sensor memory storing a datum characterizing said pressure transducer.

2. The pressure sensor of claim 1 wherein said datum characterizing said pressure transducer quantifies a nonlinearity of an output of said transducer when said transducer is exposed to a first pressure and when said transducer is exposed to a second pressure.

3. The pressure sensor of claim 1 wherein said datum characterizing said pressure transducer comprises a correction for an output of said transducer at a temperature.

4. The pressure sensor of claim 1 wherein said datum characterizing said pressure transducer comprises correction for an output of said transducer at a humidity.

5. The pressure sensor of claim 1 wherein said sensor memory comprises an electrically programmable non-volatile memory.

6. The pressure sensor of claim 1 further comprising a processor configured to read an output of said pressure sensor and modify said output of said pressure transducer by a factor stored in said sensor memory quantifying a nonlinearity of said output of said pressure transducer.

7. The pressure sensor of claim 6 further comprising a temperature sensor, said processor configured to read an output of said temperature sensor and modify said output of said pressure transducer by a factor stored in said sensor memory quantifying a correction of said output of said pressure transducer at a temperature corresponding to said output of said temperature sensor.

8. The pressure sensor of claim 6 further comprising a humidity sensor, said processor configured to read an output of said humidity sensor and modify said output of said pressure transducer by a factor stored in said sensor memory quantifying a correction of said output of said pressure transducer at a humidity corresponding to said output of said humidity sensor.

9. The pressure sensor of claim 1 further comprising a data connection to a remotely located processor configured to read an output of said pressure transducer and modify said output of said pressure transducer by a factor stored in said sensor memory quantifying a nonlinearity of said output of said pressure transducer.

10. The pressure sensor of claim 9 further comprising a temperature sensor, said remotely located processor configured to read an output of said temperature sensor and modify said output of said pressure transducer by a factor stored in said sensor memory quantifying a correction of said output of said pressure transducer at a temperature corresponding to said output of said temperature sensor.

11. The pressure sensor of claim 9 further comprising a humidity sensor, said processor configured to read an output of said humidity sensor and modify said output of said pressure transducer by a factor stored in said sensor memory quantifying a correction of said output of said pressure transducer at a humidity corresponding to said output of said humidity sensor.

12. A method of measuring a pressure with a pressure sensor, said method comprising the steps of:
(a) storing characterization data in a memory included in said pressure sensor, said characterization data quantifying non-linearity of a pressure transducer at a plurality of pressures, said pressure transducer included in said pressure sensor;
(b) reading an output of said pressure transducer;
(c) reading a characterization datum corresponding to said output of said pressure transducer; and
(d) modifying a pressure corresponding to said output of said pressure transducer to account for said characterization datum.

13. The method of measuring a pressure with a pressure sensor of claim 12, said method further comprising the steps of:
(a) storing temperature correction data in said memory, said temperature correction data quantifying non-linearity of said pressure transducer at a plurality of temperatures;
(b) reading an output of a temperature transducer; and
(c) modifying said pressure corresponding to said output of said pressure transducer to account for a temperature correction datum corresponding to said output of said temperature transducer.

14. The method of measuring a pressure with a pressure sensor of claim 12, said method further comprising the steps of:
(a) storing humidity correction data in said memory, said humidity correction data quantifying non-linearity of said pressure transducer at a plurality of humidities;
(b) reading an output of a humidity transducer; and
(c) modifying said pressure corresponding to said output of said pressure transducer to account for a humidity correction datum corresponding to said output of said humidity transducer.
